(19) United States
(12) Patent Application Publication
(10) Pub. No.: US 2023/0260292 A1
(43) Pub. Date: Aug. 17, 2023

(54) DEVICE AND METHOD FOR DETECTING ROAD MARKING AND SYSTEM FOR MEASURING POSITION USING SAME

(71) Applicants: HYUNDAI MOTOR COMPANY, Seoul (KR); Kia Corporation, Seoul (KR)

(72) Inventor: Se Jeong LEE, Suwon-si (KR)

(73) Assignees: HYUNDAI MOTOR COMPANY, Seoul (KR); Kia Corporation, Seoul (KR)

(21) Appl. No.: 17/886,766

(22) Filed: Aug. 12, 2022

(30) Foreign Application Priority Data
Feb. 17, 2022 (KR) 10-2022-0021089

(51) Int. Cl. G06V 20/56; G06V 10/44; G06V 10/26; G06V 10/764; G06V 10/762; G06T 7/73

(52) U.S. Cl. CPC G06V 20/588; G06T 7/74; G06V 10/26; G06V 10/44; G06V 10/762; G06V 10/764; G06T 2207/30256

(57) ABSTRACT

A device for detecting a road marking and a method thereof. The device includes a camera that photographs a road image, and a controller that detects class information of plural pixels in the road image, recognizes lines based on the class information of each pixel, and detects a road marking located between the recognized lines.

### CROSS-REFERENCE TO RELATED APPLICATION

This application claims the benefit of priority to Korean Patent Application No. 10-2022-0021089, filed in the Korean Intellectual Property Office on Feb. 17, 2022, the entire contents of which are incorporated herein by reference.

### TECHNICAL FIELD

The present disclosure relates to a technology for detecting (recognizing) road markings in an image based on deep learning.

### BACKGROUND

In general, deep learning (or a deep neural network), which is a type of machine learning, refers to an artificial neural network (ANN) that includes a multiple hidden layer between an input layer and an output layer.

Such an artificial neural network may include a convolutional neural network (CNN) mainly used in the vision field, a recurrent neural network (RNN) mainly dealing with sequence data such as natural language, voice, and the like, and a deep auto encoder for solving the problem that learning is not performed properly due to a lack of understanding of deep learning when the neural network is multi-layered, depending on the structure, problem to be solved, and purpose, and the like.

Meanwhile, an autonomous vehicle may recognize a road environment by itself, determine a driving situation, and control various systems in the vehicle including a steering device to move from a current position to a target position along a driving route. In this case, various systems may include an autonomous emergency braking (AEB), a forward collision warning system (FCW), an adaptive cruise control (ACC), a lane departure warning system (LDWS), a lane keeping assist system (LKAS), a blind spot detection (BSD), a rear-end collision warning system (RCW), a smart parking assist system (SPAS), and the like.

The autonomous vehicle may start to autonomous drive only after basically identifying its current location, understanding the surrounding situation, and confirming driving safety according to the current location and surrounding situation. In other words, the most important function of an autonomous vehicle is to measure its current location with high accuracy.

Such an autonomous vehicle may measure its location based on a precision map and GPS information, but the accuracy of the measured location is not high, and an error occurs between the measured location and the actual location, which acts as a factor that weakens stability as well as performance of autonomous vehicle.

The matters described in this background section are intended to promote an understanding of the background of the disclosure and may include matters that are not already known to those of ordinary skill in the art.

### SUMMARY

The present disclosure has been made to solve the above-mentioned problems occurring in the prior art while advantages achieved by the prior art are maintained intact.

An aspect of the present disclosure provides a device for detecting a road marking and a method thereof that can detect class information of plural pixels in a road image based on deep learning, recognize lines based on the class information of each pixel, and detect a bounding box of a road marking located between the recognized lines, thereby precisely measuring a position of an autonomous vehicle.

Another aspect of the present disclosure provides a system for measuring a position of an autonomous vehicle that can detect class information of plural pixels in a road image based on deep learning, recognize lines based on the class information of each pixel, detect a bounding box of a road marking located between the recognized lines, and correct a current location of the autonomous vehicle based on the road marking included in the bounding box thereof, thereby improving stability as well as performance of the autonomous vehicle.

The technical objects of the present disclosure are not limited to the above-mentioned one, and the other unmentioned technical objects and advantages will become apparent from the following description. Also, it may be easily understood that the objects and advantages of the present disclosure may be realized by the units and combinations thereof recited in the claims.

According to an aspect of the present disclosure, a device for detecting a road marking includes a camera that photographs a road image, and a controller that detects class information of plural pixels in the road image, recognizes lines based on the class information of each pixel, and detects a road marking located between the recognized lines.

According to an embodiment, the controller may detect a bounding box of the road marking and utilize the detected bounding box of the road marking to recognize the road marking included in the bounding box.

According to an embodiment, the controller may classify the pixels in the road image by class based on a classification model which completes learning and detect the class information of each pixel.

According to an embodiment, the controller may perform binary labeling based on the class information of the pixels located between the lines, extract feature points of each label of the road marking, and detect road marking based on the feature points of each label.

According to an embodiment, the controller may extract four corner points and a center point of each label as the feature points of each label.

According to an embodiment, the controller may generate a cluster by grouping labels having a distance between feature points of each label within a reference distance, and detect the generated cluster as the road marking.

According to an embodiment, the controller may laterally divide the road marking into a first road marking and a second road marking when a width of the road marking exceeds a reference width.

According to an embodiment, the controller may vertically divide the road marking into a first road marking and a second road marking when a height of the road marking exceeds a reference height.

According to an embodiment, when a first road marking and a second road marking that are adjacent to each other are detected and a combined width of the first road marking and the second road marking does not exceed a reference width, the controller may combine the first road marking and the second road marking as one road marking.

According to another aspect of the present disclosure, a method of detecting a road marking includes photographing, by a camera, a road image, detecting, by a controller, class information of plural pixels in the road image, recognizing, by the controller, lines based on the class information of each pixel, and detecting, by the controller, a road marking located between the recognized lines.

According to an embodiment, the detecting of the road marking may include detecting a bounding box of the road marking and utilizing the detected bounding box of the road marking to recognize the road marking included in the bounding box.

According to an embodiment, the detecting of the class information may include classifying pixels in the road image by class based on a classification model which completes learning, and detecting the class information of each pixel.

According to an embodiment, the detecting of the road marking may include performing binary labeling based on class information of pixels located between the lines, extracting feature points of each label of the road marking, and detecting road marking based on the feature points of each label.

According to an embodiment, the extracting of the feature points of each label may include extracting four corner points and a center point of each label as the feature points of each label.

According to an embodiment, the detecting of the road marking may include generating a cluster by grouping labels having a distance between feature points of each label within a reference distance, and detecting the generated cluster as the road marking.

According to an embodiment, the detecting of the road marking may include laterally dividing the road marking into a first road marking and a second road marking when a width of the road marking exceeds a reference width.

According to an embodiment, the detecting of the road marking may include vertically dividing the road marking into a first road marking and a second road marking when a height of the road marking exceeds a reference height.

According to an embodiment, the detecting of the road marking may include: when a first road marking and a second road marking that are adjacent to each other are detected and a combined width of the first road marking and the second road marking does not exceed a reference width, combining the first road marking and the second road marking as one road marking.

According to still another aspect of the present disclosure, a system for measuring a position of an autonomous vehicle includes a camera that photographs a road image, a road marking detection device that detects class information of plural pixels in the road image, recognizes lines based on the class information of each pixel, and detects a road marking located between the recognized lines, and a position measurement device that corrects a current position of the autonomous vehicle based on the road marking detected by the road marking detection device.

According to an embodiment, the road marking detection device may perform binary labeling based on the class information of the pixels located between the lines, extract four corner points and a center point of each label as feature points of each label, generate a cluster by grouping labels having a distance between the feature points of each label within a reference distance, and detect the generated cluster as the road marking.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an example of a vehicle system to which an embodiment of the present disclosure is applied;

FIG. 2 is a block diagram illustrating an example of a system for measuring a position of an autonomous vehicle according to an embodiment of the present disclosure;

FIG. 3 is a block diagram illustrating a configuration of a road marking detection device according to an embodiment of the present disclosure;

FIG. 4 is a diagram illustrating a line detected in a road image by a controller provided in a device for detecting a road marking according to an embodiment of the present disclosure;

FIG. 5A is a diagram illustrating a result of performing binary labeling on a road image by a controller provided in a device for detecting a road marking according to an embodiment of the present disclosure;

FIG. 5B is a diagram illustrating a process of extracting feature points of each label in a road image by a controller provided in a device for detecting a road marking according to an embodiment of the present disclosure;

FIG. 5C is a diagram illustrating a process of detecting a road marking based on feature points of each label in a road image by a controller provided in a device for detecting a road marking according to an embodiment of the present disclosure;

FIG. 6 is a diagram illustrating a process of combining road markings with each other by a controller provided in a device for detecting a road marking according to an embodiment of the present disclosure;

FIG. 7 is an exemplary diagram illustrating a process of dividing a road marking in a lateral direction by a controller provided in a device for detecting a road marking according to an embodiment of the present disclosure;

FIG. 8 is a diagram illustrating a process of dividing a road marking in a longitudinal direction by a controller provided in in a device for detecting a road marking according to an embodiment of the present disclosure;

FIG. 9 is a flowchart illustrating a method of detecting a road marking according to an embodiment of the present disclosure; and

FIG. 10 is a block diagram illustrating a computing system for executing a method of detecting a road marking according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

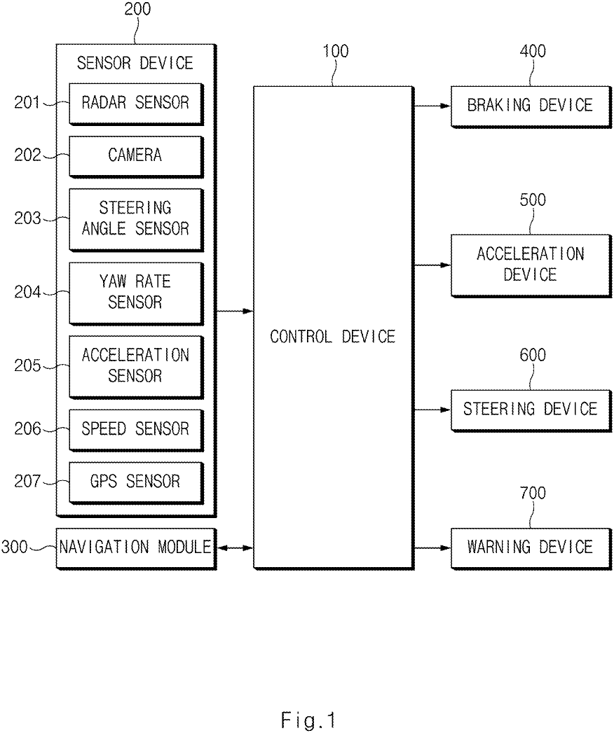

FIG. 1 is a block diagram illustrating an example of a vehicle system to which an embodiment of the present disclosure is applied.

As shown in FIG. 1, a vehicle system to which an embodiment of the present disclosure is applied may include a control device 100, a sensor device 200, a navigation module 300, a braking device 400, an acceleration device 500, a steering device 600, and a warning device 700.

The sensor device 200, which is a group of sensors for detecting vehicle driving information, may include a radar sensor 201, a camera 202, a steering angle sensor 203, a yaw rate sensor 204, an acceleration sensor 205, a speed sensor 206, and a GPS sensor 207.

The radar sensor 201 may irradiate a laser beam, detect an obstacle located in the vicinity of a vehicle through the beam that is reflected by the obstacle and returns, and measure the distance to the obstacle by measuring the time it takes for the beam to reflect and return.

The camera 202 may be implemented with a front camera, a rear camera, a first rear side camera, and a second rear side camera provided in a surround view monitoring (SVM) system 810 in order to obtain a sounding image of a vehicle. In this case, the front camera is mounted on the rear surface of a room mirror mounted inside the vehicle to photograph a front image of the vehicle, and the rear camera is mounted on an inside or outside of the vehicle to photograph a rear image of the vehicle. In addition, the first rear side camera is mounted on the left side mirror of the vehicle to photograph a first rear side image of the vehicle, and the second rear side camera is mounted on the right side mirror of the vehicle to photograph a second rear side image of the vehicle.

The camera 202 may be implemented with a multi-function front recognition camera (MFC).

The steering angle sensor 203 may be installed on a steering column to detect a steering angle adjusted by a steering wheel.

The yaw rate sensor 204 may detect a yaw moment generated when the vehicle turns (e.g., when turning in a right or left direction). The yaw rate sensor 204 may include a cesium crystal element therein. When the vehicle turns while moving, the cesium crystal element itself may generate a voltage while rotating, so that it is possible to measure the yaw rate of the vehicle based on the generated voltage.

The acceleration sensor 205, which is a module for measuring the acceleration of a vehicle, may include a lateral acceleration sensor and a longitudinal acceleration sensor. In this case, the lateral acceleration sensor may measure the acceleration in the lateral direction when the moving direction of the vehicle is referred to as the X-axis, and the vertical axis (Y-axis) direction of the moving direction is referred to as the lateral direction. The lateral acceleration sensor may detect lateral acceleration generated when the vehicle turns (e.g., when turning to the right). In addition, the longitudinal acceleration sensor may measure the acceleration in the X-axis direction, which is the moving direction of the vehicle.

The acceleration sensor 205, which is an element that detects a change in speed per unit time, may detect dynamic forces such as acceleration, vibration, shock, and the like and measure the dynamic forces by using the principles of inertial force, electric deformation and gyro.

The speed sensors 206 may be respectively installed on the front and rear wheels of the vehicle to detect the vehicle speed of each wheel while driving.

The GPS sensor 207 may receive vehicle location information (GPS information).

The navigation module 300 may receive location information from each satellite through a plurality of global positioning systems (hereinafter referred to as “GPS”) and calculate the current vehicle location. In addition, the navigation module 300 may display the calculated location through map matching on a precision map, and receive the destination from the driver to perform a route search from the calculated current location to the destination according to a preset route search algorithm. In addition, the navigation module 300 may display the searched route while matching the searched route to the map, and guide the driver to the destination along the route.

The navigation module 300 may transmit map data to the control device 100 through a communication device or AVN device. In this case, the map data may include road information necessary for driving and route guidance of a vehicle, such as a road surface indication, a road location, a road length, a speed limit of a road, and the like. In addition, the road included in the map may be divided into a plurality of road sections based on distance, whether it intersects with other roads, and the like, and the map data may include information on the locations of lines and line information (end points, divergence points, merge points, and the like) for each divided road section.

The braking device 400 may apply a braking force (braking pressure) to the wheels of the vehicle by controlling the brake fluid pressure supplied to the wheel cylinders in response to the braking signal output from the control device 100.

The acceleration device 500 may control the driving force of the engine by controlling the engine torque in response to the engine control signal output from the control device 100.

The steering device 600, which is an electric power steering (EPS) system, may receive a target steering angle required for driving of a vehicle, and may generate torque such that the wheels may be steered by following the target steering angle.

The warning device 700 may include a cluster, an audio video navigation (AVN) system, a system for driving various lamps, a steering wheel vibration system, and the like, and may provide visual, audible, and tactile warnings to the driver. In addition, the warning device 700 may use various lamps (fog lights, emergency lights and the like) of the vehicle to warn people around the vehicle (including drivers of other vehicles).

The control device 100, which controls overall operations of the vehicle, may be a processor of an electronic control unit (ECU) that controls overall operations of a driving system. The control device 100 may control operations (braking, acceleration, steering, warning, and the like) of various modules and devices built in the vehicle. The control device 100 may generate a control signal for controlling various modules, devices, and the like built in the vehicle to control the operation of each component.

The control device 100 may use a controller area network (CAN) of the vehicle. The CAN network refers to a network system used for data transmission and control between ECUs in the vehicle. In detail, the CAN network transmits data through a two-stranded data wire that is twisted or shielded by a sheath. The CAN operates in a multi-master principle in which multiple ECUs perform a master function in a master/slave system. In addition, the control device 100 may communicate through an in-vehicle wired network such as a local interconnect network (LIN) of a vehicle, media oriented system transport (MOST), and the like, or a wireless network such as Bluetooth.

The control device 100 may include a memory in which a program for performing operations described above and to be described below and various data related thereto, a processor for executing the program stored in the memory, a hydraulic control unit (HCU), a micro controller unit (MCU), and the like. The control device 100 may be integrated in a system on chip (SOC) built in the vehicle, and may be operated by a processor. However, because there is not only one system-on-chip built in the vehicle, but also a plurality of system-on-chips, the embodiment is not limited to only one system-on-chip.

The control device 100 may control the driving of the vehicle based on the signal transmitted from the sensor device 200 based on the map data transmitted from the navigation module 300.

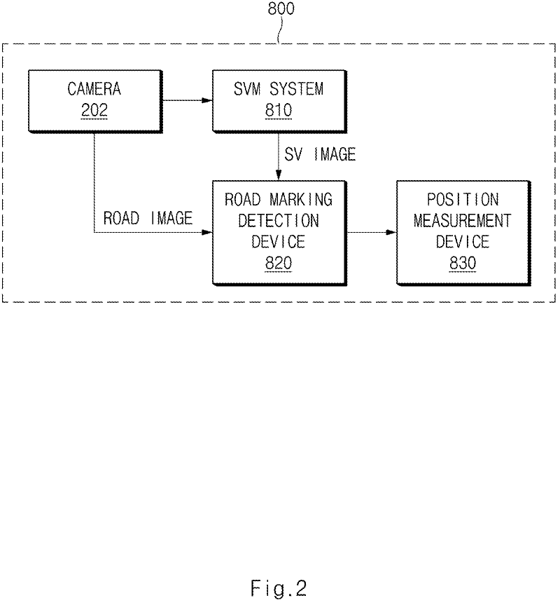

FIG. 2 is a block diagram illustrating an example of a system for measuring a position of an autonomous vehicle according to an embodiment of the present disclosure.

As shown in FIG. 2, a system 800 for measuring a position of an autonomous vehicle according to an embodiment of the present disclosure may include the camera 202, an SVM system 810, a road marking detection device 820, and a position measurement device 830. In this case, depending on a method of implementing the system 800 for measuring a position of an autonomous vehicle according to an embodiment of the present disclosure, components may be combined with each other to be implemented as one, or some components may be omitted.

Regarding each component, first, the SVM system 810 may generate a surrounding view (SV) image based on a front image, a rear image, a first rear side image and a second rear side image of the autonomous vehicle photographed by the camera 202.

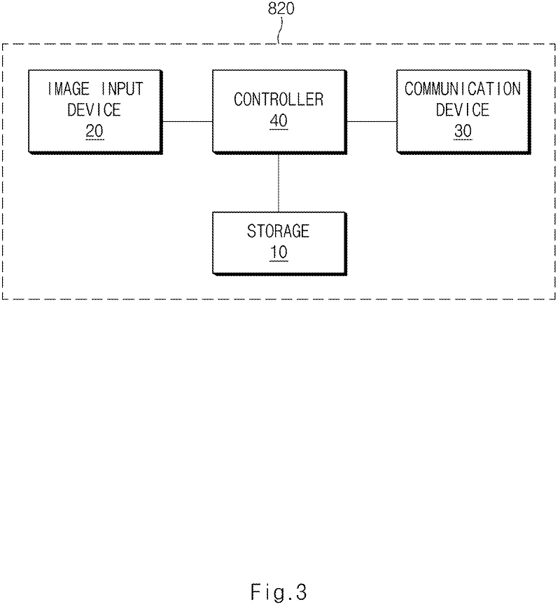

The road marking detection device 820 may detect class information of plural pixels in the road image based on deep learning, recognize lines based on the class information of each pixel, and detect a bounding box of a road marking located between the recognized lines, thereby precisely measuring a position of an autonomous vehicle. In this case, the road marking may be detected based on the SV image generated by the SVM system 810 or based on the front image of the autonomous vehicle input from the camera 202. A detailed operation of the road marking detection device 820 will be described with reference to FIG. 3.

The position measurement device 830 may measure the position of the autonomous vehicle in conjunction with the sensor device 200 and the navigation module 300. The position measurement device 830, which may be a processor, may correct the current location of the autonomous vehicle based on the bounding box of the road marking detected by the road marking detection device 820, thereby enabling precise positioning of the autonomous vehicle, thereby enabling the autonomous driving. It can improve vehicle performance as well as stability.

FIG. 3 is a block diagram illustrating a configuration of a road marking detection device according to an embodiment of the present disclosure.

As shown in FIG. 3, the road marking detection device 820 according to an embodiment of the present disclosure may include storage 10, an image input device 20, a communication device 30, and a controller 40. In this case, according to a method of implementing the road marking detection device 820 according to an embodiment of the present disclosure, components may be combined with each other to be implemented as one, and some components may be omitted.

Regarding each component, the storage 10 may store various logic, algorithms and programs required in the processes of detecting class information of plural pixels in the road image based on deep learning, recognizing lines based on the class information of each pixel, and detecting a bounding box of a road marking located between the recognized lines.

The storage 10 may store the learning-completed classification model. Such a classification model may classify pixels in a road image for each class and detect class information of each pixel.

The storage 10 may store a reference width (a specified width) that is a horizontal size and a reference height (a specified height) that is a longitudinal size as a reference size (a predetermined size) of the cluster.

The storage 10 may include at least one type of a storage medium of memories of a flash memory type, a hard disk type, a micro type, a card type (e.g., a secure digital (SD) card or an extreme digital (XD) card), and the like, and a random access memory (RAM), a static RAM, a read-only memory (ROM), a programmable ROM (PROM), an electrically erasable PROM (EEPROM), a magnetic memory (MRAM), a magnetic disk, and an optical disk type memory.

The image input device 20 may receive a road image from the camera 202 or an SV-type road image from the SVM system 810.

The communication device 30, which is a module that provides a communication interface with the position measurement device 830, may include at least one of a vehicle network connection module, a mobile communication module, a wireless Internet module, and a short-range communication module. In this case, the vehicle network may include a controller area network (CAN), a controller area network with flexible data-rate (CAN FD), a local interconnect network (LIN), FlexRay, media oriented systems transport (MOST), Ethernet, and the like.

The mobile communication module may communicate with the position measurement device 830 through a mobile communication network constructed according to a technical standard or communication scheme for mobile communication (e.g., global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTEA), 4G(4th Generation mobile telecommunication), 5G(5th Generation mobile telecommunication), and the like).

The wireless Internet module, which is a module for wireless Internet access, may communicate with the position measurement device 830 through wireless LAN (WLAN), wireless-fidelity (Wi-Fi), Wi-Fi direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), and the like.

The short-range communication module may support short-range communication by using at least one of Bluetooth™, radio frequency identification (RFID), infrared data association (IrDA), ultra wideband (UWB), ZigBee, near field communication (NFC), and wireless universal serial bus (USB) technology.

The controller 40 may perform overall control such that each component performs its function. The controller 40 may be implemented in the form of hardware or software, or may be implemented in a combination of hardware and software. Preferably, the controller 40 may be implemented as a microprocessor, but is not limited thereto.

Specifically, the controller 40 may perform various controls required in the processes of detecting class information of plural pixel in the road image based on deep learning, recognizing lines based on the class information of each pixel, and detecting a bounding box of a road marking located between the recognized lines.

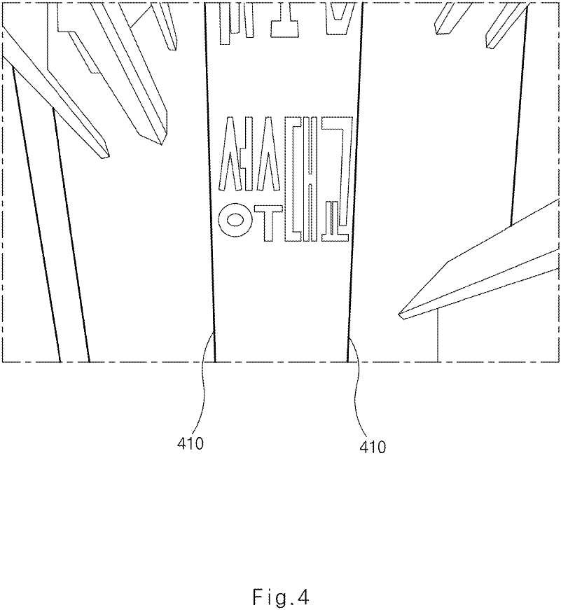

Hereinafter, the operation of the controller 40 will be described in detail with reference to FIGS. 4, 5, 6, 7 and 8.

FIG. 4 is a diagram illustrating a line detected in a road image by a controller provided in a device for detecting a road marking according to an embodiment of the present disclosure.

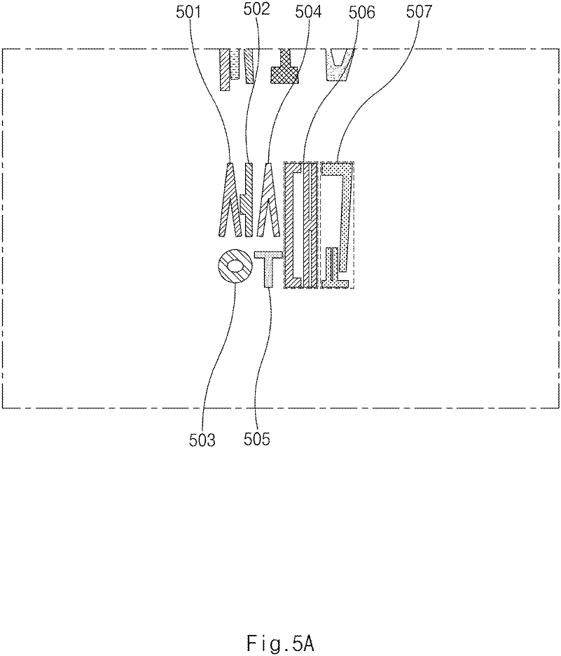

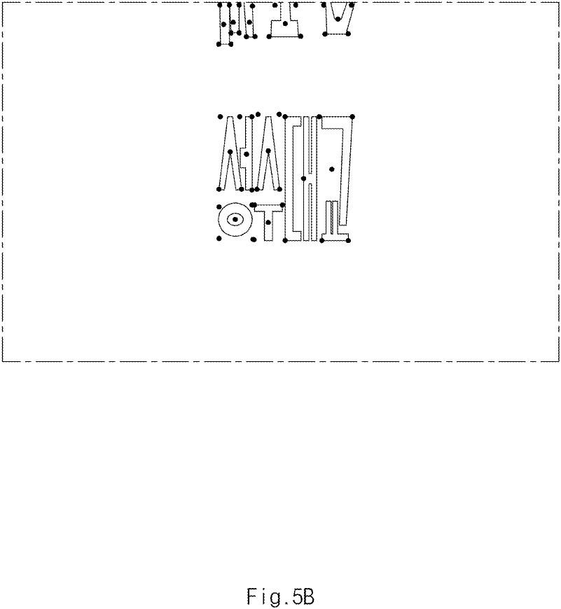

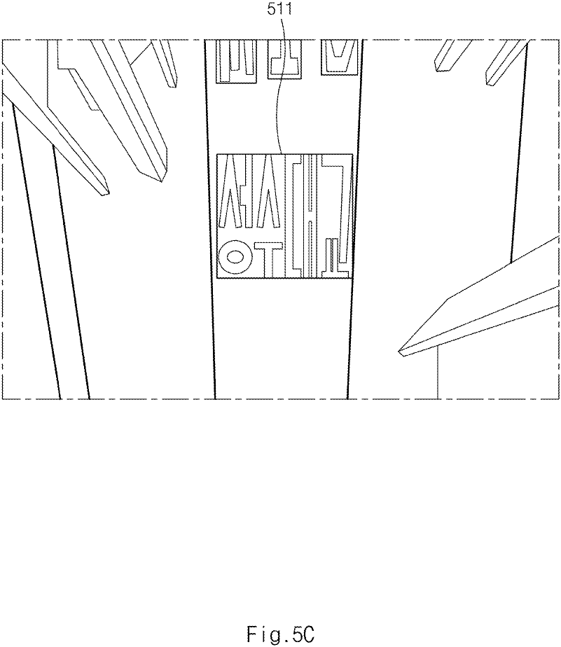

As shown in FIG. 4, the controller 40 may detect class information of each pixel in the top-view type road image received from the SVM system 810 based on a classification model stored in the storage 10, and may detect a line based on the class information of each pixel. As an example, the detected line is indicated by reference numeral 410. In this case, the class information may include a class indicating a line, a class indicating a road marking, and the like. Thereafter, as shown in FIGS. 5A, 5B and 5C, the controller 40 may perform a process of detecting road markings located between lines.

FIG. 5A is a diagram illustrating a result of performing binary labeling on a road image by a controller provided in a device for detecting a road marking according to an embodiment of the present disclosure.

As shown in FIG. 5A, the controller 40 may perform binary labeling based on class information of pixels located between lines 410. The labels generated by such binary labeling may be, for example, all seven, which include ‘ [symbol] ′ as the first label 501, ‘ [symbol] ′ as the second label 502, ‘ [symbol] ′ as the third label 503, ‘ [symbol] ′ as the fourth label 504, ‘ [symbol] ′ as the fifth label 505, ‘ [symbol] ′ as the sixth label 506, and ‘ [symbol] ′ as the seventh label 507. Then, as shown in FIG. 5B, the controller 40 may perform a process of extracting feature points of each label.

FIG. 5B is a diagram illustrating a process of extracting feature points of each label in a road image by a controller provided in a device for detecting a road marking according to an embodiment of the present disclosure.

As shown in FIG. 5B, the controller 40 may extract feature points of each label. In this case, the controller 40 may extract four corner points and the center point of the label as feature points of the label. Then, as shown in FIG. 5C, the controller 40 may perform a process of detecting a road marking based on feature points of each label.

FIG. 5C is a diagram illustrating a process of detecting a road marking based on feature points of each label in a road image by a controller provided in a device for detecting a road marking according to an embodiment of the present disclosure.

As shown in FIG. 5C, the controller 40 may generate a cluster by grouping labels in which the distance between feature points of each label is within a specified distance, and detect the generated cluster as a road marking or a bounding box of road marking. For example, the road marking 511 is ‘ [symbol] ′.

As described above, the ‘ [symbol] ′, which is the road marking 511, is a very normally detected case, and such a result is not always derived. Hereinafter, a case in which additional work is required will be described.

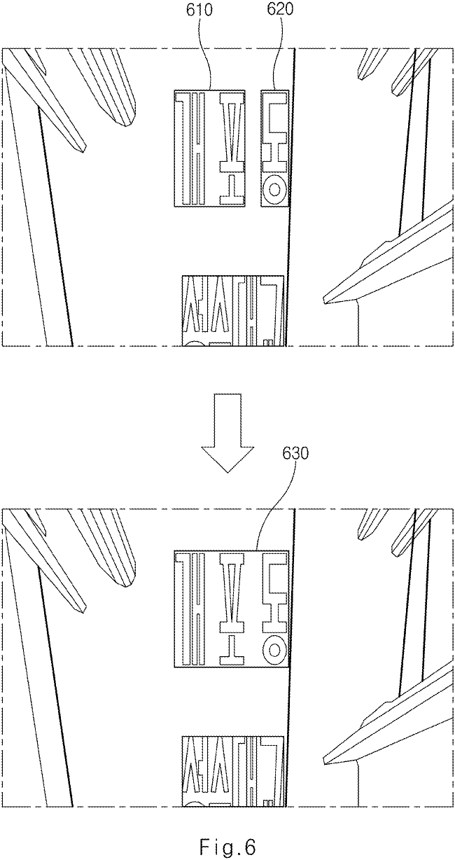

FIG. 6 is a diagram illustrating a process of combining road markings with each other by a controller provided in a device for detecting a road marking according to an embodiment of the present disclosure.

As shown in FIG. 6, the controller 40 detects ‘ [symbol] ′ as the first road marking 610 and ‘ [symbol] ′ as the second road marking 620 as the road marking. In this case, even when the first road marking 610 and the second road marking 620 are combined with each other while being adjacent to each other, the width does not exceed a specified width, so that the controller 40 may combine the first road marking 610 with the second road marking 620 to detect ‘ [symbol] ′ which is one road marking 630.

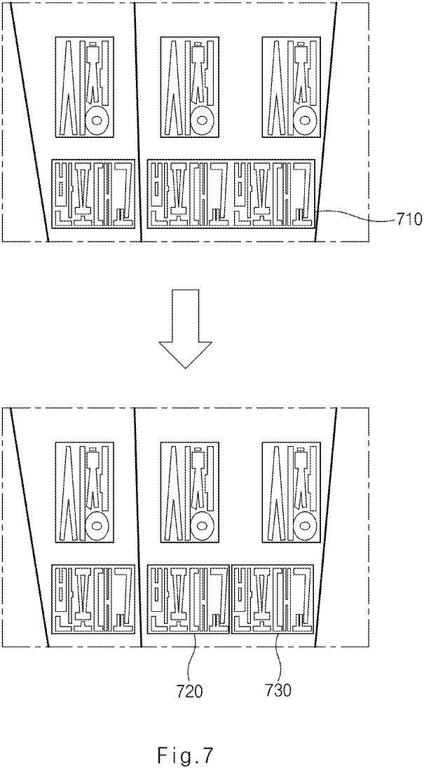

FIG. 7 is an exemplary diagram illustrating a process of dividing a road marking in a lateral direction by a controller provided in a device for detecting a road marking according to an embodiment of the present disclosure.

As shown in FIG. 7, the controller 40 detects [symbol] [symbol] ‘ as a road marking 710. In this case, because the width of the road marking 710 exceeds a reference width, the controller 40 may horizontally divide the road marking 710 into a first road marking 720 and a second road marking 730.

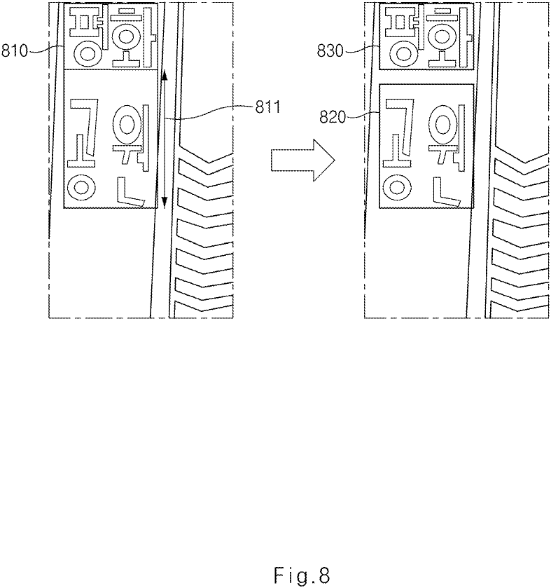

FIG. 8 is a diagram illustrating a process of dividing a road marking in a longitudinal direction by a controller provided in in a device for detecting a road marking according to an embodiment of the present disclosure.

As shown in FIG. 8, the controller 40 detects ‘ [symbol] ′ as a road marking 810. In this case, because the height of the road marking 810 exceeds a reference height 811, the controller 40 may vertically divide the road marking 810 into a first road marking 820 and a second road marking 830. In this case, the first road marking 820 is ‘ [symbol] ′ and the second road marking 730 is ‘ [symbol] ′.

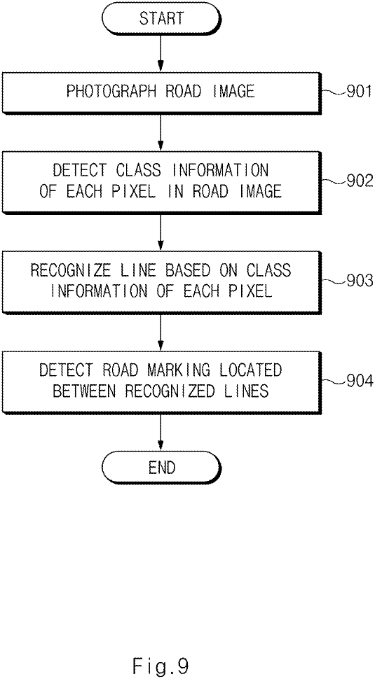

FIG. 9 is a flowchart illustrating a method of detecting a road marking according to an embodiment of the present disclosure.

First, the camera 202 photographs a road image in 901.

Then, the controller 40 detects class information of each pixel in the road image in 902.

Then, the controller 40 recognizes a line based on the class information of each pixel in 903.

Then, the controller 40 detects a road marking located between the recognized lines in 904.

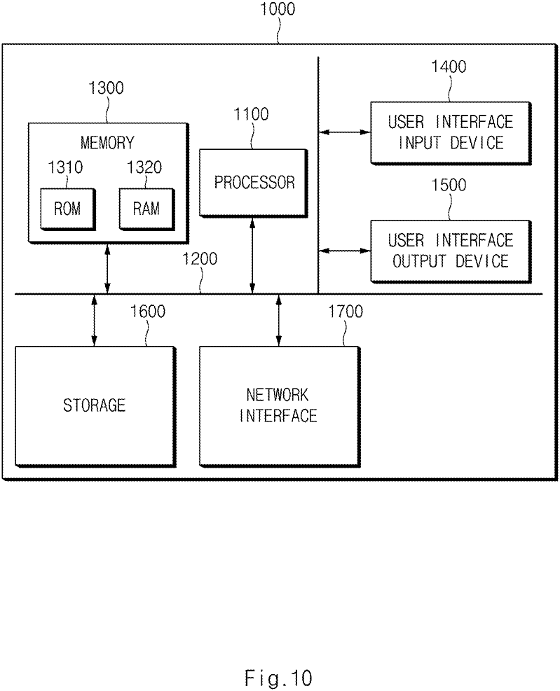

FIG. 10 is a block diagram illustrating a computing system for executing a method of detecting a road marking according to an embodiment of the present disclosure.

Referring to FIG. 10, a method of detecting a road marking controlling a hybrid vehicle according to an embodiment of the present disclosure described above may be implemented through a computing system. A computing system 1000 may include at least one processor 1100, a memory 1300, a user interface input device 1400, a user interface output device 1500, storage 1600, and a network interface 1700 connected through a system bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC) . The ASIC may reside in a user terminal. In another method, the processor and the storage medium may reside in the user terminal as an individual component.

The device and method for detecting a road marking according to the embodiments of the present disclosure may detect class information of plural pixel in a road image based on deep learning, recognize lines based on the class information of each pixel, detect a bounding box of a road marking located between the recognized lines, and utilize the detected bounding box of the road marking to recognize the road marking included in the bounding box and, ultimately, to obtain location information from the recognized road marking, thereby precisely measuring a position of an autonomous vehicle.

The system for measuring a position of an autonomous vehicle according to the embodiments of the present disclosure may detect class information of plural pixels in a road image based on deep learning, recognize lines based on the class information of each pixel, detect a bounding box of a road marking located between the recognized lines, and correct a current location of the autonomous vehicle based on the recognition of the road marking included in the detected bounding box, thereby precisely measuring a position of an autonomous vehicle.

Although exemplary embodiments of the present disclosure have been described for illustrative purposes, those skilled in the art will appreciate that various modifications, additions and substitutions are possible, without departing from the scope and spirit of the disclosure.

Therefore, the exemplary embodiments disclosed in the present disclosure are provided for the sake of descriptions, not limiting the technical concepts of the present disclosure, and it should be understood that such exemplary embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. A device for detecting a road marking, the device comprising:
a camera configured to photograph a road image; and
a controller configured to detect class information of plural pixels in the road image, recognize lines based on the class information of each pixel, and detect a road marking located between the recognized lines.

2. The device of claim 1, wherein the controller is configured to detect a bounding box of the road marking.

3. The device of claim 1, wherein the controller is configured to classify the plural pixels in the road image by class based on a classification model which completes learning and to detect the class information of each pixel.

4. The device of claim 1, wherein the controller is configured to perform binary labeling based on the class information of the pixels located between the lines, to extract feature points of each label, and to detect road marking based on the feature points of each label.

5. The device of claim 4, wherein the controller is configured to extract four corner points and a center point of each label as the feature points of each label.

6. The device of claim 4, wherein the controller is configured to generate a cluster by grouping labels having a distance between feature points of each label within a reference distance, and to detect the generated cluster as the road marking.

7. The device of claim 1, wherein the controller is configured to laterally divide the road marking into a first road marking and a second road marking when a width of the road marking exceeds a reference width.

8. The device of claim 1, wherein the controller is configured to vertically divide the road marking into a first road marking and a second road marking when a height of the road marking exceeds a reference height.

9. The device of claim 1, wherein, when a first road marking and a second road marking that are adjacent to each other are detected and a combined width of the first road marking and the second road marking does not exceed a reference width, the controller is configured to combine the first road marking and the second road marking as one road marking.

10. A method of detecting a road marking, the method comprising:
photographing, by a camera, a road image; and
detecting, by a controller, class information of plural pixels in the road image;
recognizing, by the controller, lines based on the class information of each pixel; and
detecting, by the controller, a road marking located between the recognized lines.

11. The method of claim 10, wherein the detecting of the road marking includes:
detecting, by the controller, a bounding box of the road marking.

12. The method of claim 10, wherein the detecting of the class information includes:
classifying, by the controller, the plural pixels in the road image by class based on a classification model which completes learning; and
detecting, by the controller, the class information of each pixel.

13. The method of claim 10, wherein the detecting of the road marking includes:
performing, by the controller, binary labeling based on the class information of the pixels located between the lines;
extracting, by the controller, feature points of each label; and
detecting, by the controller, road marking based on the feature points of each label.

14. The method of claim 13, wherein the extracting of the feature points of each label includes:
extracting, by the controller, four corner points and a center point of each label as the feature points of each label.

15. The method of claim 13, wherein the detecting of the road marking includes:
generating, by the controller, a cluster by grouping labels having a distance between feature points of each label within a reference distance; and
detecting, by the controller, the generated cluster as the road marking.

16. The method of claim 10, wherein the detecting of the road marking includes:
laterally dividing, by the controller, the road marking into a first road marking and a second road marking when a width of the road marking exceeds a reference width.

17. The method of claim 10, wherein the detecting of the road marking includes:
vertically dividing, by the controller, the road marking into a first road marking and a second road marking when a height of the road marking exceeds a reference height.

18. The method of claim 10, wherein the detecting of the road marking includes:
when a first road marking and a second road marking that are adjacent to each other are detected and a combined width of the first road marking and the second road marking does not exceed a reference width, combining, by the controller, the first road marking and the second road marking as one road marking.

19. A system for measuring a position of an autonomous vehicle, the system comprising:
a camera configured to photograph a road image;
a road marking detection device configured to detect class information of plural pixels in the road image, recognize lines based on the class information of each pixel, and detect a road marking located between the recognized lines; and
a position measurement device configured to correct a current position of the autonomous vehicle based on the road marking detected by the road marking detection device.

20. The system of claim 19, wherein the road marking detection device is configured to perform binary labeling based on the class information of the pixels located between the lines, extract four corner points and a center point of each label as feature points of each label, generate a cluster by grouping labels having a distance between the feature points of each label within a reference distance, and detect the generated cluster as the road marking.
